(19) United States
(12) Patent Application Publication
(10) Pub. No.: US 2008/0260182 A1
(43) Pub. Date: Oct. 23, 2008

(54) Sound Recording Console

(76) Inventor: Michael Paul Stavrou, New South Wales (AU)

Correspondence Address: Blakely Sokoloff Tayloy & Zafman LLP, 12400 Wilshire Boulevard, 7th Floor, Los Angerles, CA, 90025, US

(21) Appl. No.: 11/660,805

(22) PCT Filed: Aug. 22, 2005
(86) PCT No.: PCT/IB05/02933

§ 371 Date: Mar. 11, 2008

(30) Foreign Application Priority Data
Aug. 20, 2004 (GB) 0418648.2
Aug. 23, 2004 (GB) 0418831.4

(51) Int. Cl. H04H 60/04

(52) U.S. Cl. 381/119

(57) ABSTRACT

The invention relates to a console 1 for use in electronic control operations such as sound recording and/or other effects or applications, comprising a plurality of channels and a transparent touch-sensitive channel selector means 2 operative to select a desired channel of the console, the means 2 being an elongate member, suitably curved, ergonometrically positioned with respect to a position of a user and associated with means adapted to provide a desired function of the console when the means 2 is actuated.

The invention relates to a sound recording console.

Sound recording consoles are generally physically large so much so that they are longer than the arm span of an operator who often has physically to move to left or right along the console in order to operate channels, faders and modules which are at or adjacent one end of the other of the console. Such movement by an operator is time-consuming an therefore expensive, and tiring and therefore prone to lead to errors in operation, which can result in a poor “take” with consequent need for repetition, which again is expensive. With long consoles, the operator is rarely positioned in the acoustic centre of the sound image. This results in coarse manipulations of the sound. Space is also a major consideration in this age of high rent and shrinking real estate. Large rooms for long consoles mean expensive rents. Future studios may not have the room for a 60-channel console. Long digital consoles are extremely expensive. Moreover, it is often not possible to provide such a console with a multiplicity of functions.

Assignable control surfaces reduce the control surface area by reducing the number of knobs on a panel by making them either assignable or multifunction controls.

An axiom of console design states that if the number of knobs on a panel is reduced, thus necessitating reassignment of those knobs now present, the number of actions on the part of the operator must inevitably be increased to compensate. Put simply, if a collection of knobs are within reach and a designer now removes half of them, additional keystrokes or actions are always required to toggle the function of those remaining knobs to the functions of all the now out of reach controls. Present day means of reassigning these controls use traditional computer interfaces which are inherently keystroke intensive and include bank switching the physical controls, scrolling through lists on a screen, and using a mouse and a keyboard to access a list.

It is accordingly an object of the invention to seek to mitigate these disadvantages.

According to the invention there is provided a control console for use in electronic control operations such as sound recording and/or other applications, comprising a plurality of channels, and a touch sensitive channel selector means operative to select a desired channel of the console, the channel selector means comprising an elongate member positioned ergonometrically with respect to a position of a user, and means associated with the channel selector means adapted to provide a desired function of the console, when the means is actuated.

Using the invention it is possible to access selected remote channels from a central position of the console. This arrangement provides for an ergonomic arrangement so that an operator may sit in front of the console substantially centrally thereof and operate all channels from one lateral extremity of the console to the other. In one embodiment there may be 60 or more channels.

As will be apparent in such a console, the channel selector means may bear a plurality of touch sensitive areas or elements along its length.

Further, there may be as many such sensitive areas as there are selectable channels of the console. By “touch sensitive” too it will be understood that touching by finger or thumb is meant and that this includes both a distinct pressure in a certain part of the selector means or “wiping” along it over part or all of its length.

The channel selector means and associated means may comprise an integral unit.

The integral unit may comprise a planar unit adapted to receive multiple touches and to display an image.

The channel selector means and/or unit may be initially separate from the console and may be adapted for connection therewith, e.g. by an electrical or by infra-red means, or by retro-fitting to an existing console.

The channel selector means may be positioned at, over or adjacent an edge of the console remote from a users' position.

In a preferred embodiment, the means may fly over the console surface like a bridge. This provides for ease of use particularly when the selector means may be made of a translucent material such as glass or plastic, for example an elongate plastic member, which may suitably comprise a plastic rod, bar or strip, which may be mounted flush in, or stand proud of, a fascia of the console. The member may preferably be cylindrical.

The elongate member may alternatively be a glass member.

The channel selector means cooperate with sensors which may determine exactly within which channel area or segment of the channel selector a touch is occurring at all times.

The member may be curved. This provides for a “fit” or “match” with a curved body part of the console. Stated in another way, the selector means and console may be complementary in shape, at least adjacent an edge or side thereof.

The member may be cylindrical. This provides for positive action of the console in use.

There may be a plurality of discrete means which are disparate but which can be used individually or in any combination to provide desired sound results or effects when using the console in say a recording, mixing or dubbing studio or suite, or other industries, such as the Film, TV or Video/DVD industries, or other locations such as power station control rooms.

Thus the means may comprise a fader device adapted to assign a channel to a fader slot.

The means may alternatively or in addition comprise a fader activity overview device, or may be such as to be adapted to bank switch the channel selector means.

Further, the means may comprise a device adapted to store a collection of assigned channels (of the console), for example, the device may comprise a store button or buttons adapted to store when actuated a current collection of channels activated by the channel selector member.

There may be an extension device adapted to extend the channel selector means whilst maintaining it within reach of a user.

The means may be adapted to bank switch the channel selector means to provide a composite layer of channels (of the console).

The means may further comprise means adapted for transcription of user writing or printings, whereby to provide for display of the writing or printing.

Preferably the transcription means may be used in conjunction with a visual image collection, device whereby to display the writing or printing in a larger display. Such an arrangement is particularly effective when the visual image collection device may comprise a camera or hand-scanner.

The console may comprise means adapted to allow update of channels, the means preferably comprising the channel selector means and a strip modifier means, suitably in the form of separate buttons.

A control console for use in sound recording and/or effects such as mixing, dubbing, editing, overlaying or the like is hereinafter described by way of example with reference to the accompanying drawings.

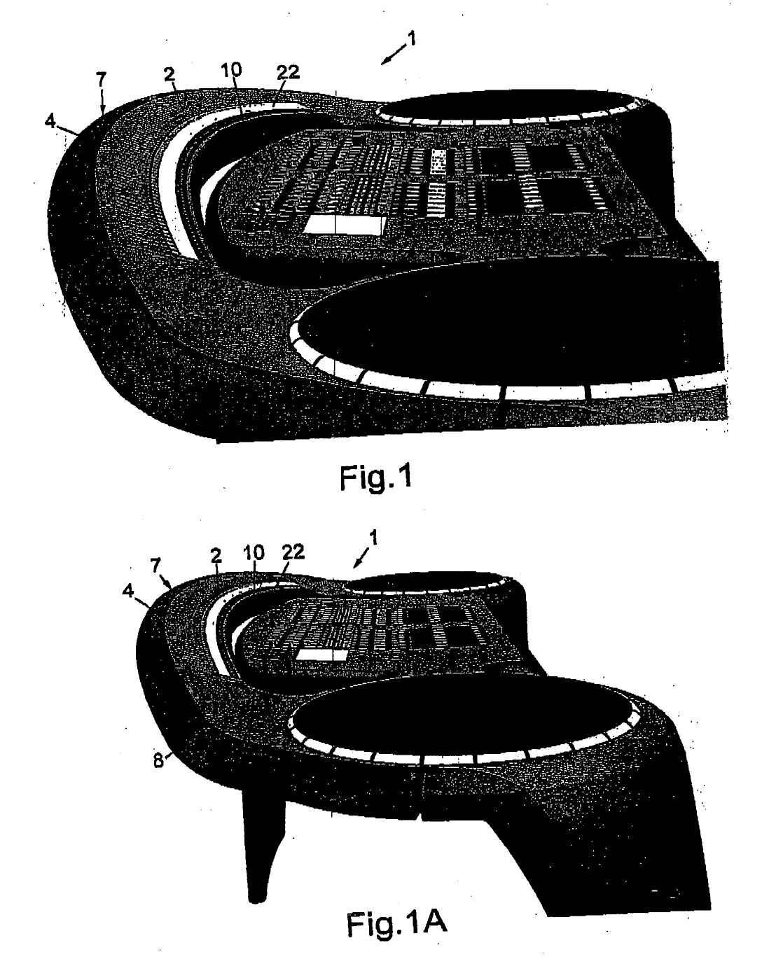

FIG. 1 is a schematic perspective view from above and one side of part of an embodiment of console embodying the invention;

FIG. 1A is a schematic perspective view of the console of FIG. 1, to a smaller scale;

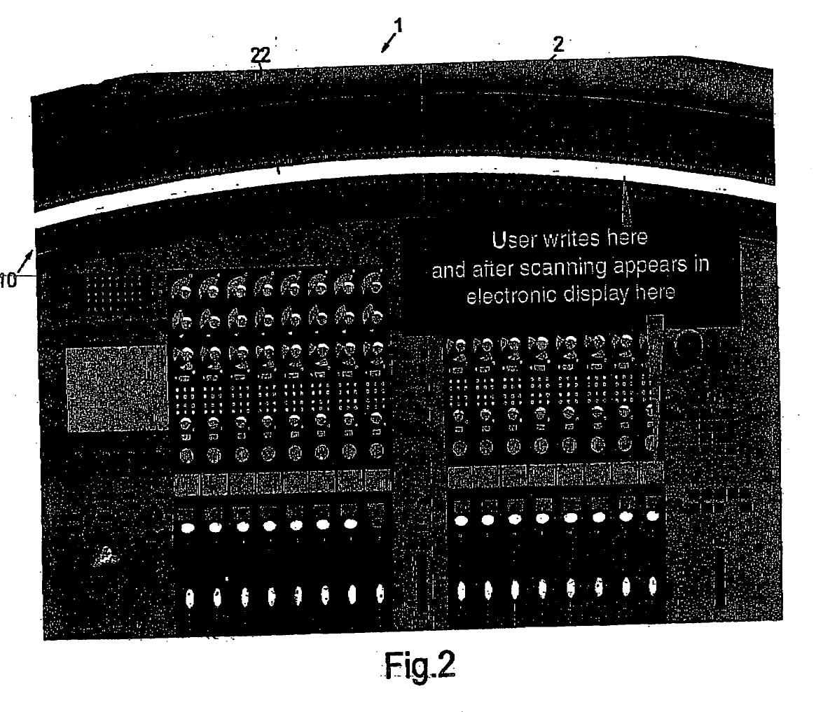

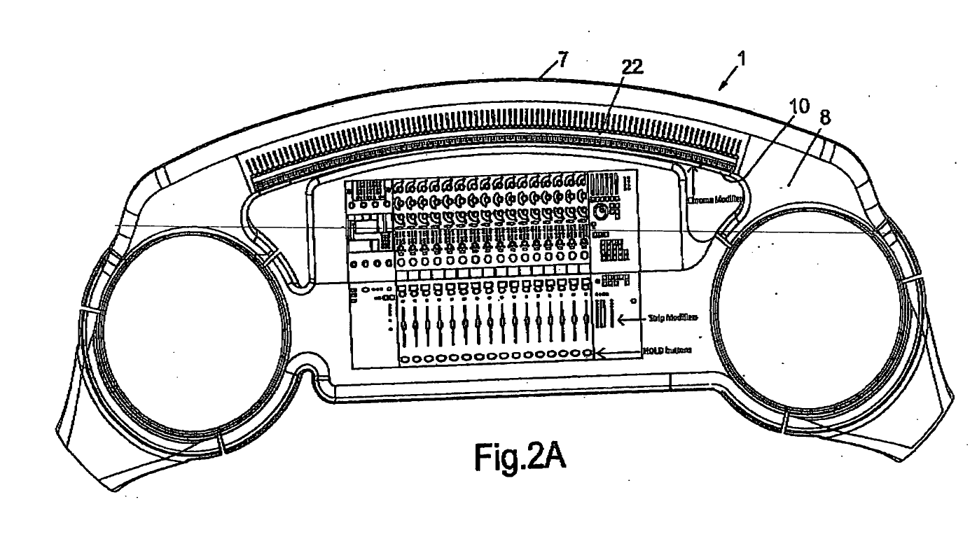

FIG. 2 is a schematic plan view substantially centrally of the part of the console of FIG. 1; FIG. 2A is a plan view, also schematic of the whole console of FIG. 2;

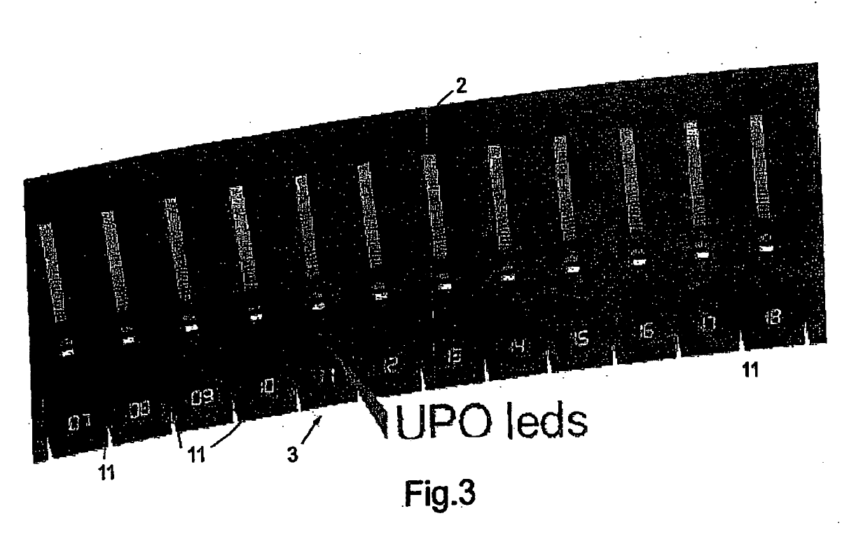

FIGS. 3 to 6 are schematic plan views of separate means of the console to provide respective desired effects, either singly or in combination;

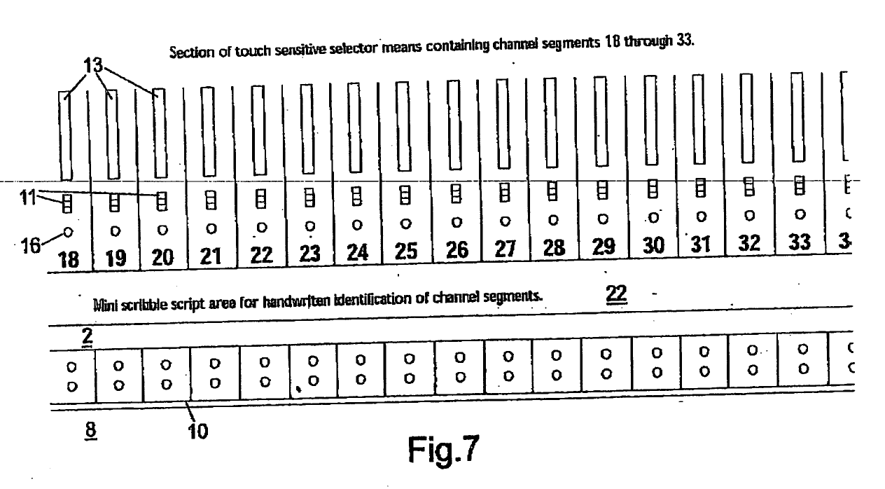

FIG. 7 is a schematic plan view of a section of part of the console according to the invention; and

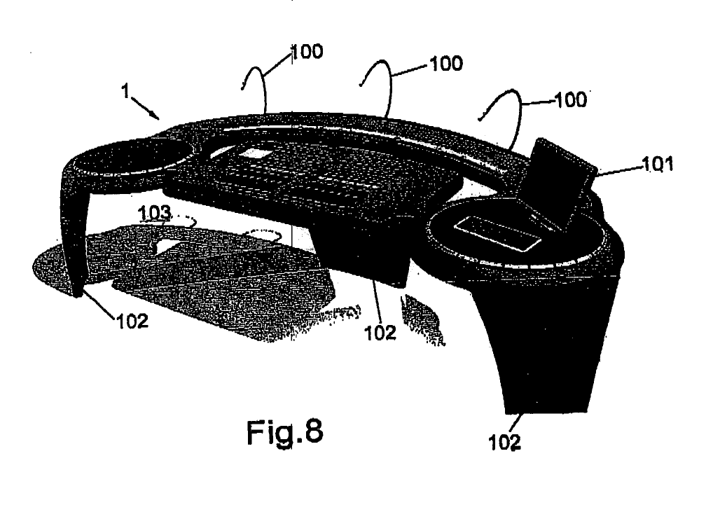

FIG. 8 is a schematic perspective view of a further embodiment of console according to the invention.

Referring to the drawings, there is shown (FIGS. 1, 1A) a control console 1 for use in electronic control operations such as sound recording and/or effects, for example mixing, dubbing, editing, overlaying or the like. It will be understood too that although sound effects are referred to, the console could be used for editing film, videos, TV, DVDs and the like visual media. It will also be understood that the console can be used in any industrial application that may benefit from reducing thousands of repetitive controls to a few dozen, including but not limited to power stations, train controls, security systems, any command control situation that requires the operator to have a strong sense of overview while instantly accessing individual controls within it. The console 1 comprises a plurality of channels, e.g. sound channels, and a touch sensitive channel selector means 2 operative to select a desired channel of the console 1, the channel selector means 2 comprising an elongate member positioned ergonometrically with respect to a position of a user, and means 3 to 6 associated with the channel selector means 2 adapted to provide a desired function of the console 1 when the means is actuated.

The channel selector means 2 is a translucent, elongate member in the form of a rod which in the embodiment shown is glass or plastic, curved and is mounted centrally, but towards a top edge 7 of a body 8 of the console 1. By top edge 7 is meant an edge which is at a side of the body of the console 1 opposite the side (which is lower in use), where an operator of the console is positioned, usually on a seat, centrally of the console. The console 1 includes a multiplicity of channels which are accessed/selected by touching the selector means 2 which has as many touch sensitive areas as there are channels, the areas being suitably defined by metal studs carried by the channel selector means 2, being suitably defined by optical touch points situated centrally of each segment which emit an infrared beam of light that strikes the user's fingertip to bounce back into an infrared detector. This permits the lightest touch of all. In fact it operates even when the finger is one millimeter away from the glass rod.

The rod 2 actually protrudes a few millimeters from a fascia 9, is not flush therewith, so as to facilitate touching. However, the rod 2 could be flush with a fascia of the console 1.

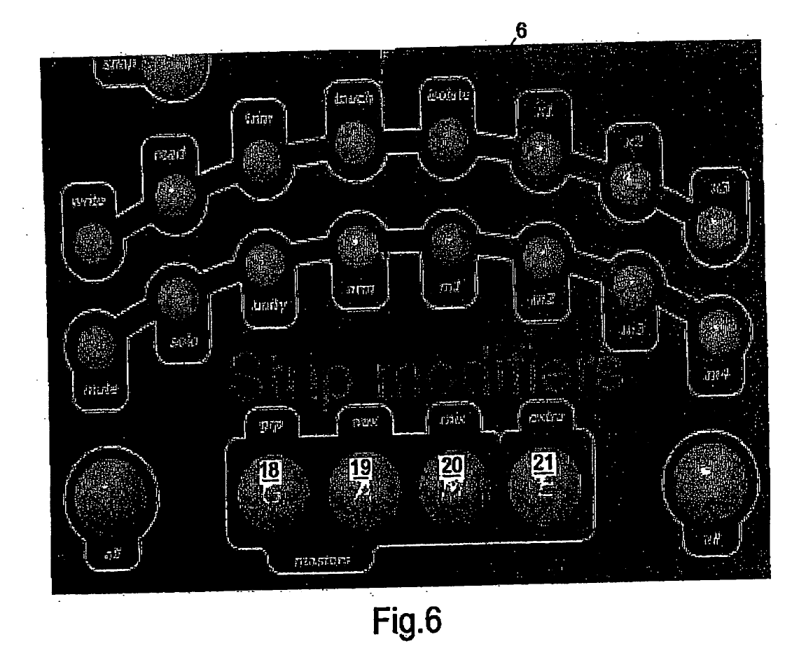

The touch sensitive channel selector means 2, namely the rod, may be considered as a main selector strip of the console. Associated with it and of complementary curved shape in the embodiment is an additional touch sensitive means 10 comprising in the embodiment a metal wire, suitably a relatively thick wire, which extends the length of the rod 2 and is positioned so that a thumb of a user can touch it at any time whilst touching or “wiping” the touch sensitive channel selector means, namely the rod 2. This combination of channel selector means 2 and additional means 10 in the form of the wire rod provides that in use when a user is touching or wiping segments of the rod whilst also touching the metal wire 10, the channels selected will mute, or solo, or apply any parameter assigned to strip modifier buttons. Such buttons, referred to in more detail in FIG. 6, when used in conjunction with segments of the means 2 apply or past elements or plug-ins to channels, touched on the selector means. Any parameter or function can be assigned to a wire rod or strip, see below. This is particularly effective as the wire 10 can be touched at any time and therefore provides for the omission of a row of dedicated mute and/or solo actuating means such as buttons along the channel selector means. The wire rod is shown in FIGS. 1 and 2.

FIG. 2A shows a plan view of the console 1.

Turning now to FIG. 3, there is shown an enlarged part of the channel selector means or rod 2, each touch sensitive segment of which has a light emitting display or LED 11. Such LEDs 11 provide indicators which effectively provide a user with a user programmable overview of the status of the channels selected as they extend along the length of the rod 2 and automatically light if their channels match the status of the currently manipulated parameter of the last physical channel. Thus if the phase of a channel is inverted by a user then all channels which are inverted by use of an appropriate dedicated phase button causes the LEDs 11 to illuminate on the channel selector means 2. This ensures that if a user pans to the left, all channels so panned, for example panned hard left, light their LEDs 11. If moreover a channel is compressed, each time a signal exceeds a compressor threshold on all the channels, the LEDs light up for a duration of the gain reduction. The LEDs 11 may be “locked” to a particular parameter if so desired. Moreover, the channel selector means can be bank-switched by using suitable devices such as buttons at its ends. Pressing a “bank” button essentially extends the use of the channel selector means 2 from 60 channels to a second selection of 60 channels, in the embodiment. A third device such as a third “bank” button is provided which can select a “composite” layer upon which elements from any other bank may be posted or overlayed to create a customised combination of channels which are available via the channel selector means. In operation a bank button say “A” is pressed for the touch or wipe channels, those touched being remembered by software in the order or sequence of being touched. If it is desired to create a composite layer, a composite layer say “C” button is pressed and the channel selector means is touched or wiped to load those previously touched into the composite layer where touched e.g. from bank “A” touch channels 2, 3, 4, 5,6, 1 and 10 could be a sequence of channels touched or wiped. The composite layer button “C” is then pressed and the channel selector means is wiped from segment 8 upwards to segment 13 to position bank “A”'s so that channels 2, 3, 4, 5,6, 1 and 10 are wiped into segments 8 to 13 of the layers covered by button “C”, in that order thus using this means a mode of creating a composite layer is provided essentially by selecting by finger the relevant channels, effectively “sticking” them there only to provide them on to a new layer.

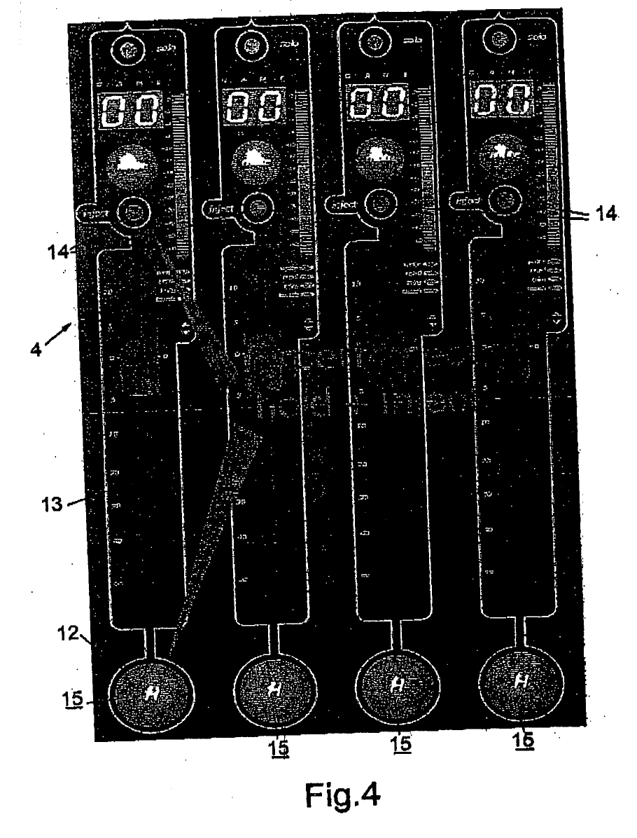

Turning now to FIG. 4, the means 12 shown there to provide an additional function is such that a single fader 13 can be locked or latched so that a button 14 used to “inject” that fader 13 is effectively permanently active. That button 14 is indicated for each fader, strip or channel and effectively means that when a user touches or wipes the channel selector means 2, the channel associated with each segment touched or wiped becomes instantly assigned to that particular fader 13, known as a fader slot. There is an additional button 15 for each fader 13 and which is associated with the inject button 14. Button 15 is depressed, then the button 14 is used to “inject” the desired fader. Thus there is a Latched Inject Mode provided by the console of the invention.

Thus it is possible to balance all instruments being used during recording with only one hand and one fader with the other hand slowly touching or wiping the channel selector means.

The fader is just one example. Thus, suppose it is necessary to create a headphone mix for all of the musicians and that aux send #1 on each channel strip provides the level of each channel to those musicians. Traditionally on a known long console a user would adjust each echo send one knob after the other as he/she slides their chair along the desk, (no doubt tangling a headphone lead in the process). On assignable consoles a user forever reassigning multifunction controls from channel to channel in various cumbersome methods. In the present invention, while in Latched Inject Mode, a user places a hand on only one aux send control while sliding a finger along the selector means 2. The headphone send knob is active at all times so if the control is set to say, the 12 o'clock position and a finger slides across 10 channels on the rod 2, all of those channels have been sent to the 12 o'clock position. This same degree of ergonomic efficiency is applicable to any channel parameter in this Latched Inject Mode. As a finger slides along the rod 2 you could be adjusting Pan Pot of each channel, panning this one here, and that one there, with great speed. There are real active variable controls. Activating the solo button on the channel slot in this mode could solo individually each channel as they enter this slot. A coordinated engineer/operator can during production randomly grab channels on the strip 2 with one hand while modifying the parameter of choice with the other—all without moving their head—all because of this powerful Latched Inject Mode of FIG. 4.

With only a small change in operation the same body can be moved to copy parameters from one channel to many others. A parameter setting can be stored from one of these (or any combination of) channel strip controls into a spare strip modifier button. This is achieved by first pressing and holding a strip modifier button and then touching all of the parameter controls that a user would like to copy into that button. Now to paste those settings into other channels hold that modifier button is simply pressed and held again while the operator touches or wipes those channels on the touch sensitive selector means.

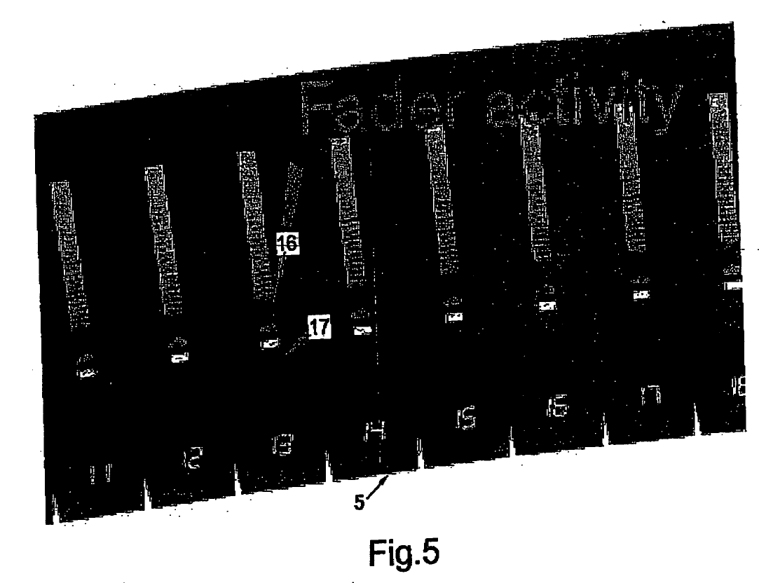

Turning now to FIG. 5, which is an enlarged view of FIG. 3, shows additional LEDs 16, 17 which provide fader activity overview indicators in the form of two LEDs 16, 17 one above the other, one 16 being adapted to light up while a fader is moving upwards while the other 17 lights up while a fader is moving downwards and then extinguishes once the fader halts. This thus provides an optimal way of providing an overview of fader movements with minimum additional construction and elements as there are two LEDs instead of a separate screen required to be provided for each status of the faders.

Turning now to FIG. 6, it will be understood that the channel selector means usually contains musical instrument sources but it could equally comprise pipes and pathways that these sounds, from the musical sources, subsequently feed. Therefore the console 1 provides a plurality of devices 18, 19, 20, 21 such as buttons which may be pressed in order to bank-switch entire selector means to reflect groups, auxiliary masters, mix masters and extras. In use, by pressing and/or holding the button 19 “A” (auxiliary master) if the channel selector means 2 is now wiped from segments 1-4 this will provide to the physical fader (channel, strips) auxiliary masters 1-4 and not instrument channels 1-4.

The buttons 18-21 function as Group, Aux, Mix and Extra control devices, i.e. GAME devices, which enable a user of the console to store any channel parameter or function for subsequent application to other channels selected by the selector means 2. Stated in another way, the buttons 18-21 (in the embodiment) function as a modifier of the means 2 (i.e. as a strip modifier) to allow an operator to apply or update parameters to selected channels without having first to bring them (or select them) to channel strip slots, usually physical slots.

It will also be appreciated that further modifications are possible. For example there may be a vertical strip containing rows of devices such as buttons which effectively extend the range of operation of the channel selector means whilst allowing it to remain within reach. Thus the vertical strip may be at each side of the channel selector means 2 to give a wide “H” kind of configuration or —1—1—. Touching a button on the vertical selector strip assigns its own dedicated special channels to fader slots.

FIG. 7 shows a plan view of part of the console. There are, from top to bottom as viewed, faders 13, fader activity LEDs, UFO light, the channel number, a strip for writing notes, the touch sensor 2, solo indicator, mute indicator and wire (or chrome modifier) strip.

The console 1 also provides adjacent to the channel selector means, effectively between it and the wire additional touch point, a “write board” 22 in the form of a curved device which extends the length of the channel selector 2 means and is effectively a scribble script transposition for user handwriting. The write board is actually adjacent but above the rod so that the user's finger does not cover handwriting when selecting. The selector means is between the write board and the wire. Thus a user writes on to the write board 22 where desired along the length of the channel selector means 2. This area is then scanned with a camera or hand-scanner technology and is displayed electronically in the larger display in the fascia of the console, where all the control buttons etc. are located. Thus as shown in FIG. 2 the large display may be above the fader channels 13.

It will be understood that the transparent channel selector means 2, which is touch sensitive, transmits light or infrared radiation from appropriate transmitters positioned beneath it in the fascia of the console. The means 2, being a cylindrical rod in the preferred embodiment, focuses ambient light or infrared radiation from the transmitters onto a user's finger or thumb tips when the strip 2 is touched back through the strip 2 to receivers therefor located adjacent the transmitters. The channels 2, 3, 4, 5, 6 comprise channel strips which are a collection of dedicated controls in the embodiment, primary controls available to each channel being manifested in an associated channel strip. The respective channel numbers are indicated e.g. from 18-33 in FIG. 7, below each fader meter 13 for example, fader activity leds 11 and UPO, below each fader meter 13 for light 16.

It will also be understood that the touch sensitive channel selector means 2 has three basic functions in a console 1 embodying the invention.

Firstly, the means 2 provides an overview of all selectable channels by displaying channel numbers, names and selected high priority indicators, e.g. mute, solo, fader activity, metering during music production.

Secondly, by touching the means 2 channel strip slots brings selected channels to channel strips containing their controls. Thus for audio application there are contained levels, pan positions, equalisers, echo sends, sound compressors, routing matrix and the like.

Thirdly, the means 2 with the strip modifiers 18-21 allows a user to update channels, in other words to apply parameters to the channels represented by the selector means without having first to assign them to the channel strips physically part of the console 1 and below the means 2.

FIG. 8 shows a console with additional elements such as adjustable lights 100 and a laptop 101. The console 1 is free standing, on legs 102 and has a front, in use, area 103 where an operator is situated.

It will be understood too that the console includes software for all the channels and moreover, that there may be included a timer which is actuated with each touch or wipe of the channel selector means to define when the selection process begins. This effectively times the beginning of a fresh wipe or touch of the channel selection means for example for filling in fader slots from a side such as from the left.

It will be understood too that the term “channels” used herein includes applications where data is stored for access electronically in databases.

Furthermore, although described hereinbefore as near the top of the console, the channel selector means 2 may be positioned at any position (FIG. 7 for example) or adjacent any edge of the console 1 remote from a user's operating position. Moreover, the channel selector means may be integral with the console, being fitted thereto as by bonding or moulding, or may be separate as by being adjacent to and separate from the console to which it may be operatively connected by wires, electrical cables, infra-red means or the like for communicating with the console.

The term “channels” is a general term which includes all such databases.

1. A control console for use in electronic control operations comprising a plurality of channels, and a touch sensitive channel selector means operative to select a desired channel of the console, the channel selector means comprising an elongate member positioned ergonometrically with respect to a position of a user, and means associated with the channel selector means adapted to provide a desired function of the console when the means is actuated.

2. A console according to claim 1, the channel selector means and associated means comprising an integral unit.

3. A console according to claim 2, the integral unit comprising a planar unit adated to receive multiple touches and to display an image.

4. A console according to claim 1, the channel selector means being separate from the console and being adapted for connection herewith.

5. A console according to claim 2, the unit being separate from the console and being adapted for connection therewith.

6. A console according to claim 1, the selector means being positioned adjacent an edge of the console remote from a user's position.

7. A console according to claim 6, the selector means comprising an elongate plastic and glass material.

8. A console according to claim 3, the member comprising a plastic rod.

9. A console according to claim 4, the plastic rod being curved.

10. A console according to claim 7, the member being cylindrical.

11. A console according to claim 1, the associated means comprising a device to provide that at least one channel is selected from a mute and solo mode when actuating the channnel selector means.

12. A console according to claim 1, said means which are operative to indicate that channels to which they are connected match the status of a parameter of a channel actuated by the selector means.

13. A console according to claim 12, the means comprising a fader device adapted to assign a channel to a fader slot.

14. A console according to claim 12, the means comprising a fader activity overview device.

15. A console according to claim 12, the means being adapted to bank-switch the channel selector means.

16. A console according to claim 12, the means comprising a device adapted to store a collection of assigned channels.

17. A console according to claim 16, the device comprising a store button adapted to store when actuated a current collection of channels activated by the channel selector means.

18. A console according to claim 1, comprising an extension device adapted to extend the channel selector means whilst maintaining it within reach of a user.

19. A console according to claim 1, the means being adapted to bank-switch the channel selector mean to provide a composite layer of channels.

20. A console according to claim 1, the means comprising means adapted for transcription of user inscription, whereby to provide for display of the inscription.

21. A console according to claim 20, the transcription means being used in conjunction with a visual image collection device whereby to display the inscription in a larger display.

22. A console according to claim 21, the visual image collection device comprising a camera.

23. A console according to claim 21, the visual image collection device comprising a hand-scanner.

24. A console according to claim 1, comprising means adapted to allow update of channels.

25. A console according to claim 24, the means comprising the channel slector means and a strip modifier means.
